(19) United States
(12) Patent Application Publication
(10) Pub. No.: US 2014/0106115 A1
(43) Pub. Date: Apr. 17, 2014

(54) Structure of Handgrip Cushion Pad

(71) Applicant: UNIVERSAL TRIM SUPPLY CO., LTD., New Taipei City (TW)

(72) Inventor: SHIH-SHENG YANG, New Taipei City (TW)

(73) Assignee: UNIVERSAL TRIM SUPPLY CO., LTD., New Taipei City (TW)

(21) Appl. No.: 14/141,373

(22) Filed: Dec. 26, 2013

Related U.S. Application Data
(63) Continuation-in-part of application No. 12/701,591, filed on Feb. 7, 2010.

(30) Foreign Application Priority Data
Nov. 28, 2013 (TW) 102222287

(51) Int. Cl. B62K 21/26; B32B 3/12

(52) U.S. Cl. CPC B62K 21/26; B32B 3/12
USPC 428/116

(57) ABSTRACT

A handgrip cushion pad includes two ciliated bodies that are made of an elastic material and each have a surface on which a plurality of uniaxial pouches is formed to be arranged in an alternate form. The uniaxial pouches of the first ciliated body have a height that is greater than a height of the uniaxial pouches of the second ciliated body. The second ciliated body includes through holes formed therein to respectively correspond to the uniaxial pouches of the first ciliated body. To assemble, the two ciliated bodies are attached to each other with the pouched surfaces facing each other and top ends of the uniaxial pouches of the first ciliated body penetrating through and projecting beyond the through holes. The top ends of predetermined ones of the pouches are each provided with an expanded flange, which is forced through the through hole to form a retention engagement therewith.

### CROSS-REFERENCE TO RELATED APPLICATION

This is a continuation-in-part of co-pending U.S. patent application Ser. No. 12/701,591 filed on Feb. 7, 2010 and owned by the present applicant.

### TECHNICAL FIELD OF THE INVENTION

The present invention generally relates to a structure of a cushion pad that comprises an arrangement of dual layers, which can be combined to show a planar or cylindrical configuration to be applicable to a cushioning material for planar loading, such as cushioning material for a backpack, or a cylindrical form of cushioning material for use in a handgrip of for example a bicycle and a motorcycle.

### DESCRIPTION OF THE PRIOR ART

A rider of a bicycle or a motorcycle uses both hands to hold and operate a handlebar in order to control the advancing direction. However, the hands may get sweating during riding and, also, the hands may get sore and aching due to vibration transmitted from the vehicle body, so that the sense of holding and stability of the hands are greatly affected. Some riders are used to wear gloves when they are riding. Most of the gloves that are available in the market for riding are made of fabric or leather, which can effectively isolate the skins of the hands from contacting with the handgrips so as to prevent the sweats of the hands from wetting the handgrips. However, these conventional gloves provide only a function of slip resistance and they are not capable of damping shocks and alleviating impacts.

To cope with such problems, some of the manufacturers provide gloves that are soft, air-permeable, and shock damping. The gloves are made of a soft plastic material or a rubber material and are generally flexible gloves, which have a palm section comprising air tubes concentrated at several sites. The air tubes provide a comfortable sense of holding and also achieve an effective function of shock absorption for vibration transmitted from the road surface during riding.

Such conventional gloves are effective in damping shocks and alleviating impacts, but they must be provided in a number of different sizes in order to meet the needs of wearers who may have different sizes of hands. Further, such gloves are generally made of injection molding so that for each size of the gloves, there must be a corresponding mold prepared. In addition, molding flaws, such as difficulties of injection molding and product damages occurring in de-molding, easily occur in the processes of injection molding. These lead to poor yield rate of production. Consequently, the manufacturers suffer wastes of time, labor, and money and are also poor in market competition power due to increased manufacturing cost.

Further, U.S. patent application Ser. No. 12/701,591, which is own by the present applicant, discloses an “air cushion pad”, which shows an embodiment in FIGS. 33-38 thereof, characterized by using a rigid upper lid and a rigid lower lid to sandwich a sheet member having a plurality of tubes therebetween, wherein the rigid upper lid comprises a plurality of holes receiving the plurality of tubes of the sheet member to fit therein in such a way that the plurality of tubes extends beyond the rigid upper lid so as to provide a property for cushioning an impact caused by an external force. However, such a localized structural arrangement is such that the rigid upper lid is generally not flexible, making it not possible to curve and bend, and is fit for applications to a handgrip cushion pad that is generally of a cylindrical configuration. When the cushion pad that is provided for making a cylindrical handgrip cushion pad is curved and bent to form a cylindrical configuration, all the tubes must be properly positioned in order to achieve a desired cylindrical configuration. Thus, an excellent structural arrangement for assembling is necessary.

In view of this, the present invention aims to provide a structure of a handgrip cushion pad that has a simple structure for easily making a structure having a shock-absorbing function into a cylindrical configuration for mounting to a handgrip to be used by general consumers for the purposes of dampening shocks and alleviating impact forces.

### SUMMARY OF THE INVENTION

The primary object of the present invention is to provide a structure of a handgrip cushion pad that has a simple overall structure, is easy to manufacture, and provides a pouched structure having a dual-layer shock absorption function to effectively dampen shocks and alleviate impact forces.

Another object of the present invention is to provide a structure of a handgrip cushion pad, which has an advantage of being convertible into a planar dual-layered cushion pad or a cylindrical dual-layered cushion pad according to the needs of use.

To achieve the above objects, the present invention provides a structure of a handgrip cushion pad, which comprises a first ciliated body and a second ciliated body. The ciliated bodies are made of an elastic material and each have a surface on which a plurality of uniaxial pouches is formed to be arranged in an alternate form. Further, the uniaxial pouches of the first ciliated body have a height that is greater than a height of the uniaxial pouches of the second ciliated body. Further, predetermined ones of the uniaxial pouches of the first ciliated body located on predetermined portions of the first ciliated body being each provided, at a top end thereof, with an expanded flange. The second ciliated body comprises through holes formed therein to respectively correspond to the uniaxial pouches of the first ciliated body, whereby to assemble, the two ciliated bodies are attached to each other with the pouched surfaces facing each other and the top ends of the uniaxial pouches of the first ciliated body penetrating through and projecting beyond the through holes of the second ciliated body to provide a surface of the second ciliated body with a plurality of boss like structures. Further, the expanded flanges on the top ends of the pouches are forced through the through holes to form retention engagement therewith to thereby fix the two ciliated bodies together to form a cushion pad having a planar or cylindrical dual-layer pouched structure. As such, the pouches provide a function of shock absorption that can alleviate impact and achieve effectiveness of shock dampening and protection.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating assembly of an embodiment of the present invention as a planar pad.

FIG. 1A is an enlarged view of a circled portion of FIG. 1 designated at A.

FIG. 1B is an enlarged view of a circled portion of FIG. 1 designated at B.

FIG. 2 is a cross-sectional view illustrating the assembly of the embodiment of the present invention as a planar pad

FIG. 3 is a perspective view of the embodiment of the present invention as a planar pad in an assembled form.

FIG. 4 is a cross-sectional view of the embodiment of the present invention as a planar pad in an assembled form.

FIG. 4A is an enlarged view of a circled portion of FIG. 4 designated at A.

FIG. 5 is a perspective view illustrating assembly of an embodiment of the present invention as a cylindrical pad.

FIG. 6 is a perspective view of the embodiment of the present invention as a cylindrical pad in an assembled form.

FIG. 7 is a cross-sectional view of the embodiment of the present invention as a cylindrical pad in an assembled form.

FIG. 8 illustrates an example of an application of the present invention to a handgrip.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

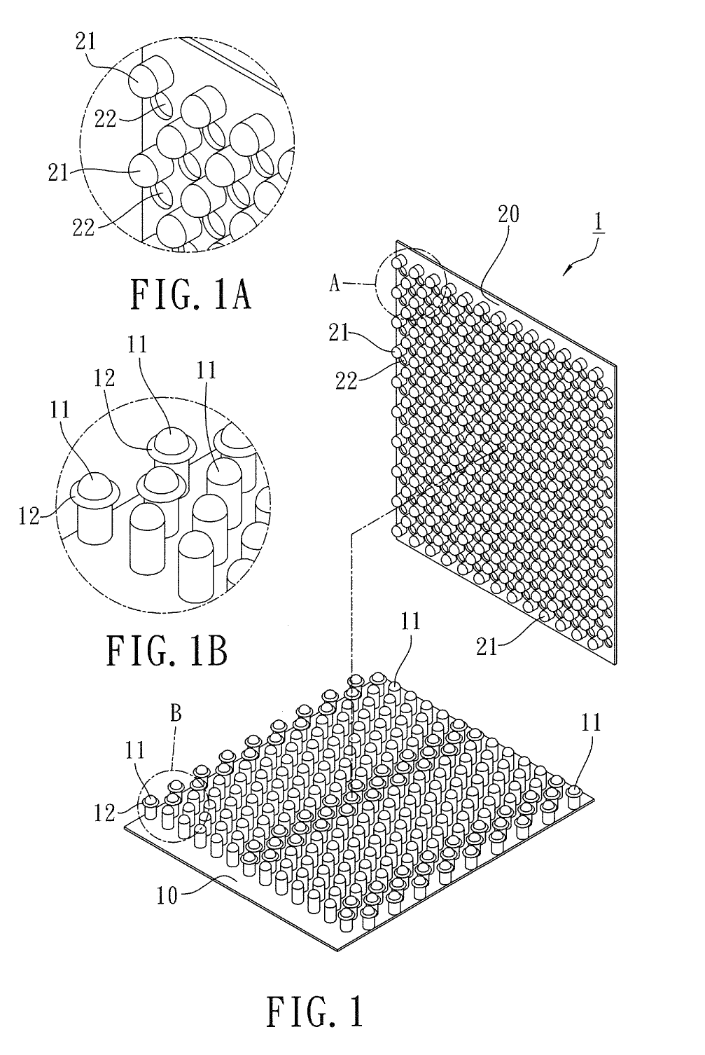

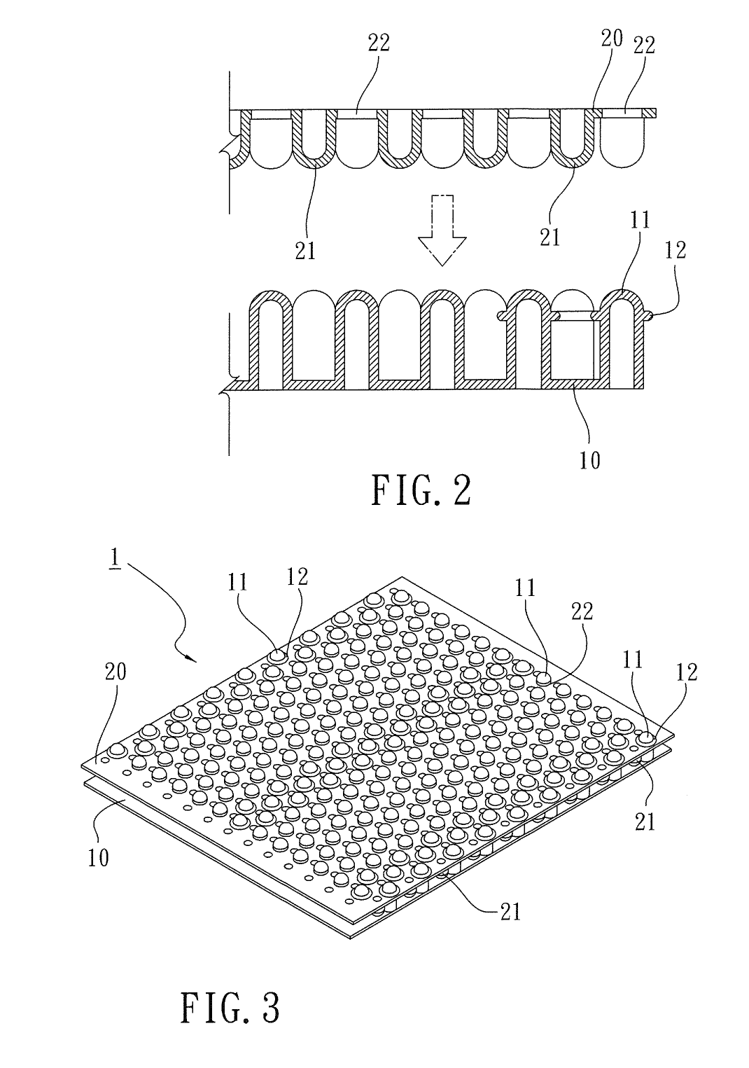

Referring to FIGS. 1 and 2, the present invention provides a structure of a handgrip cushion pad 1, which is generally composed of a first ciliated body 10 and a second ciliated body 20. To manufacture, the first ciliated body 10 and the second ciliated body 20 are made of plastic materials that have properties of elasticity by means of hot pressing in such a way that a surface of each of the two different ciliated bodies (10, 20) is formed with a plurality of hollowed uniaxial pouches (11, 21) extending in a predetermined axial direction (as shown in FIGS. 1A and 1B). Further, the uniaxial pouches 11 of the first ciliated body 10 are made to have a height greater than that of the uniaxial pouches 21 of the second ciliated body 20, whereby the first ciliated body 10 and the second ciliated body 20 are inter-fit to each other with the uniaxial pouches 11 and the uniaxial pouches 21 arranged in an alternating manner. Further, the first ciliated body 10 also comprises an expanded flange 12 formed at a top end of each of predetermined ones of the uniaxial pouches 11 that are located at specific positions. In the instant embodiment, the expanded flange 12 is provided on each of the pouches that are located in two opposite side edge portions and a central portion of ciliated body. The second ciliated body 20 Comprises through holes 22 formed therein to respectively correspond to the uniaxial pouches 11 of the first ciliated body 10. As such, the first and second ciliated bodies (10, 20) can be combined, according to the need of use, to form a planar or cylindrical configuration of a cushion pad 1.

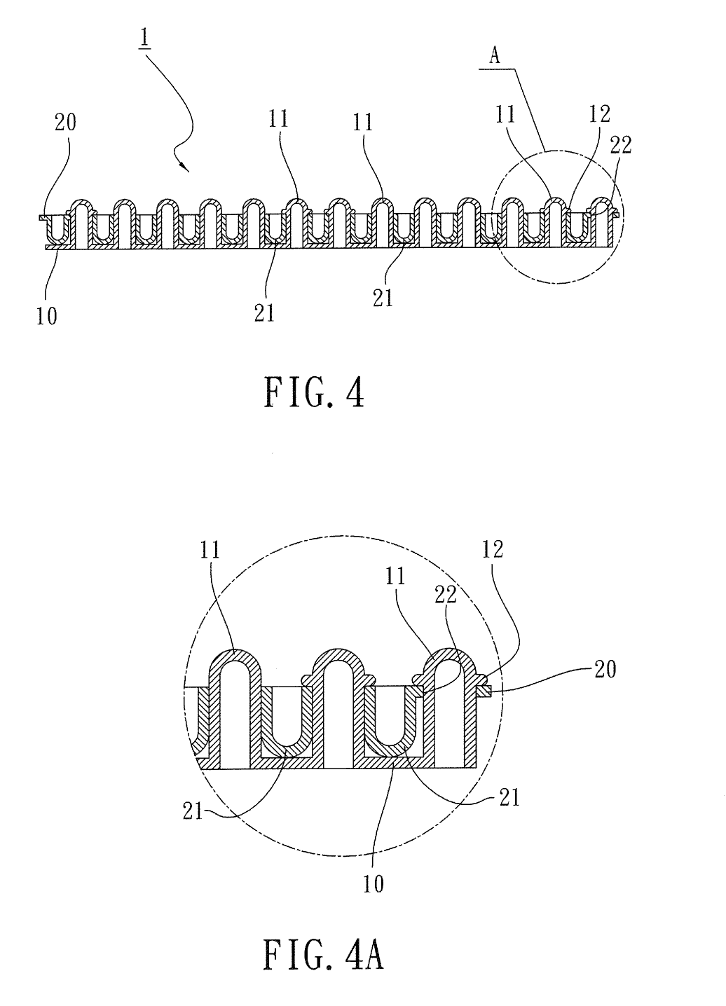

Referring to FIGS. 2-4 and 4A, an embodiment where the cushion pad 1 of the present invention is made in a planar configuration is illustrated. The pouched surfaces of the first and second ciliated bodies (10, 20) are attached to each other in a face-to-face manner so as to be combined together. During the attachment, since the uniaxial pouches 11 of the first ciliated body 10 have a height greater than that of the uniaxial pouches 21 of the second ciliated body 20, with the uniaxial pouches 21 of the second ciliated body 20 being set in contact engagement with the first ciliated body 10 with top end thereof, the top ends of the uniaxial pouches 11 of the first ciliated body 10 are allowed to penetrate through the through holes 22 to project beyond the second ciliated body 20 to form a plurality of boss like structures on an external surface. The expanded flanges 12 that are formed on predetermined ones of the uniaxial pouches 11 are forced through the through holes 22 to each engage a circumference of a corresponding one of the through hole so as to fix the two ciliated bodies (10, 20) together to form a structure of a planar cushion pad 1. As such, the pouches that penetrate through and project beyond the external surface with boss like structures and the pouches interposed between the ciliated bodies constitute dual layers of shock absorption that help achieve alleviating of impact and realizing shock dampening and protection.

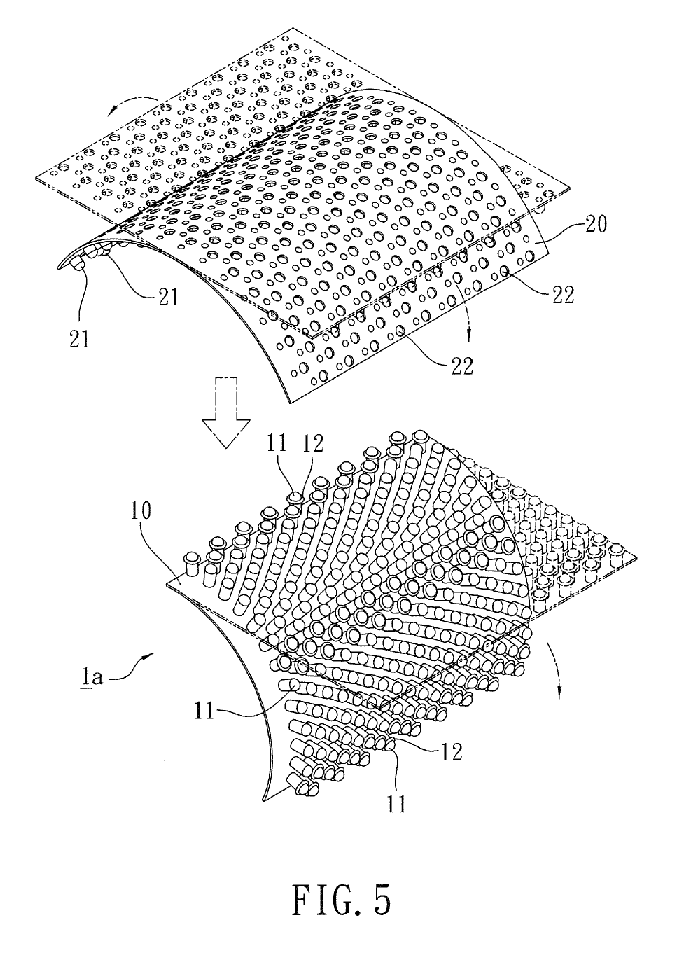

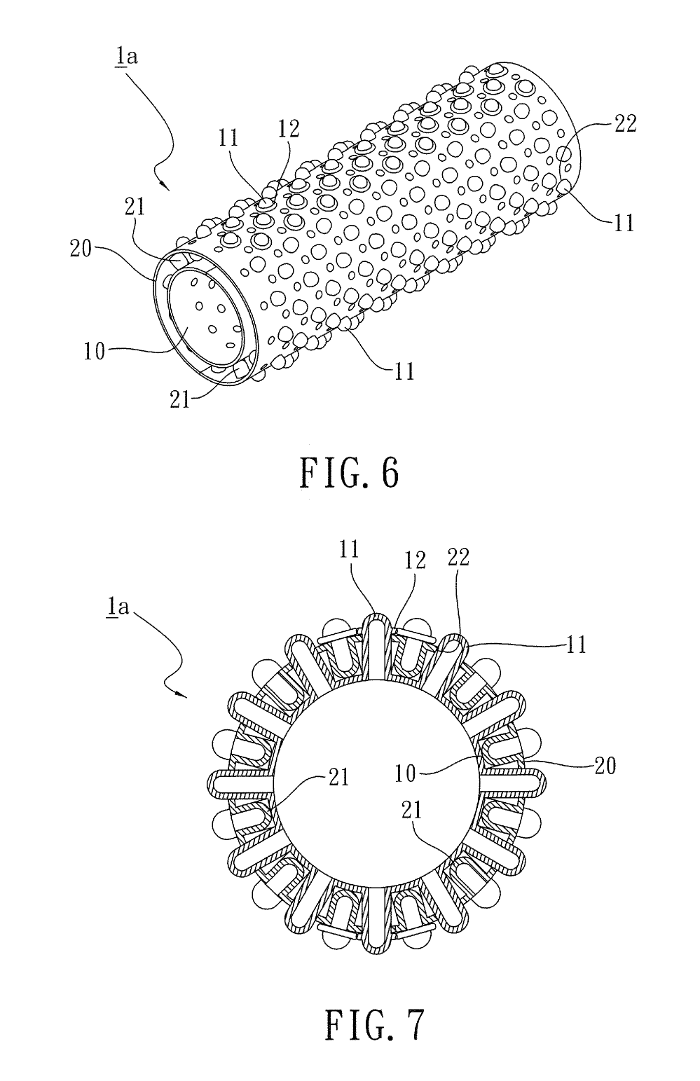

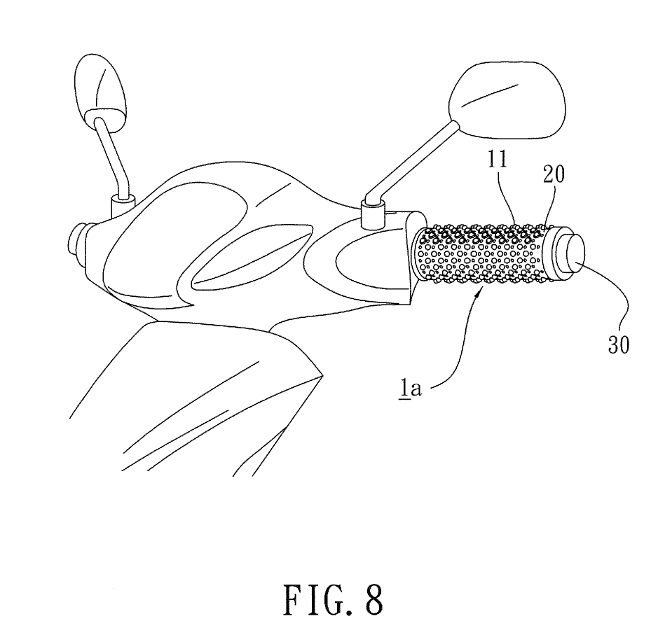

Referring to FIGS. 5-8, an embodiment where the cushion pad 1a of the present invention is made in a cylindrical configuration is illustrated. The embodiment is made with such a size as to correspond to a circumference and a length of a handgrip 30 of a motorcycle or a bicycle, wherein the first ciliated body 10 is curved, with the pouched surface thereof facing outward, to form a cylindrical shape and the second ciliated body 20 is set, with the pouched surface thereof facing inward, to wrap around and couple to an outer circumference of the first ciliated body 10 in such a way that the top ends of the uniaxial pouches 11 of the first ciliated body 10 penetrate through the through holes 22 and project outside the second ciliated body 20 with the expanded flanges 12 of the top ends of the predetermined ones of the pouches forced through the corresponding through holes 22 and set in engagement with the circumferences of thereof so as to form a cylindrical configuration of a cushion pad 1a having a surface comprising a plurality of boss like structures projecting therefrom. As such, when the cushion pad 1a is mounted to the handgrip 30 of a motorcycle (or a bicycle), a soft and comfortable sense of holding is achieved with the pouches having the boss like structures projecting beyond the surface and also sweating of a hand holding the handgrip can be alleviated to enhancing the power of the hand holding the handgrip. Further, vibrations generated in riding can be absorbed to alleviate the feeling of sore and aching of the hand. In addition, the pouches interposed between the ciliated bodies can effectively alleviate the forces of impacts in case of emergent stop or being subjected to violent shocks so that effectiveness of dual layer based shock dampening and protection is achieved.

Further, in other embodiments that are shown in the drawings, the first ciliated body 10 can be made in such a form that most of the uniaxial pouches 11 are made to be of different heights arranged according a predetermined pattern of distribution, such as increasingly heightening from two sides toward the center, whereby the outside surface of a handgrip to which the cushion pad is mounted provides a sense of holding of a convex curve. This is believed to belong to the scope of the present invention.

To this point, it can be appreciated that the present invention possesses the following practical advantages:
(1) Simple components are used to make a cushion pad that provides a dual-layer shock-damping pouched arrangement to effectively alleviate impact forces and achieve effectiveness of shock damping and protection.
(2) Assembly can be made according to applications to alternatively form a cushion pad having a planar dual-layered shock-damping structure or a cylindrical dual-layered shock-damping structure.
(3) Manufacture can be fulfilled with a hot-pressing old that is of a relatively low cost as a substitute to a relatively expensive injection mold and additionally, the yield rate of production can be enhanced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A handgrip cushion pad, which comprises a first ciliated body and a second ciliated body and is characterized in that:
the first ciliated body and the second ciliated body are made of an elastic material and each have a surface on which a plurality of uniaxial pouches is formed to be arranged in an alternate form, the uniaxial pouches of the first ciliated body having a height that is greater than a height of the uniaxial pouches of the second ciliated body, predetermined ones of the uniaxial pouches of the first ciliated body located on predetermined portions of the first ciliated body being each provided, at a top end thereof, with an expanded flange, the second ciliated body comprising through holes formed therein to respectively correspond to the uniaxial pouches of the first ciliated body, whereby the two ciliated bodies are assembled together through attachment to each other, the top ends of the uniaxial pouches of the first ciliated body respectively penetrate through the through holes to project outside the second ciliated body with the expanded flanges of the predetermined pouches forced through the through holes to form retention engagement therewith to thereby fix the two ciliated bodies together to form a cushion pad having a dual-layer pouched structure.

2. The handgrip cushion pad according to claim 1, wherein the plurality of uniaxial pouches formed on the surface of each of the two ciliated bodies comprises hollow cylinders.

3. The handgrip cushion pad according to claim 1, wherein the two ciliated bodies are assembled together to form a cushion pad having a planar or cylindrical dual-layer pouched structure.

4. The handgrip cushion pad according to claim 1, wherein the first ciliated body is made in such a form that the uniaxial pouches have different heights and are arranged in a predetermined distribution pattern to provide a sense of holding of a convex curve for a handgrip to which the cushion pad is mounted.
